(19) United States
(12) Patent Application Publication
(10) Pub. No.: US 2002/0138301 A1
(43) Pub. Date: Sep. 26, 2002

(54) Integration of a portal into an application service provider data archive and/or web based viewer

(76) Inventors: Thanos Karras, Mount Prospect, IL (US); Greg Angst, Cary, IL (US); Milton Silva-Craig, Arlington Heights, IL (US)

Correspondence Address: MCANDREWS HELD & MALLOY, LTD, 500 WEST MADISON STREET, SUITE 3400, CHICAGO, IL, 60661

(21) Appl. No.: 09/681,345

(22) Filed: Mar. 22, 2001

(51) Int. Cl. G06F 17/60

(52) U.S. Cl. 705/2; 705/4

(57) ABSTRACT

A preferred embodiment of the present invention provides a method and system for integration of a portal into an application service provider data archive and/or web based viewer. In a preferred embodiment, the system includes a data center for storing medical content and/or medical services. The data center is remotely accessible by a portal. The portal allows access to the medical content and/or medical services at the data center. The system also includes a portal/data center connection allowing communication between the portal and the data center.

### BACKGROUND OF INVENTION

The preferred embodiments of the present invention generally relate to medical information systems, and in particular relate to a method and system for integration of a Portal into an Application Service Provider (ASP) Data Archive (Archive) and/or Web Based Viewer (Viewer).

Healthcare practitioners, such as physicians, nurses, assistants, or technicians, for example, rely on information to diagnosis and treat patients. For example, healthcare practitioners may use medical content such as patient images, patient data, medical data, medical libraries, and/or educational materials, for example, to diagnose and treat patients. The information may be obtained through direct examination, but the information may also be obtained through the efforts of colleagues and others.

Additionally, healthcare practitioners may use resources such as scheduling tools, administrative tools, and/or time management tools, for example, to assist in the diagnosis and treatment of patients. Resources may be used to schedule events, such as patient examination, patient operation, and/or patient transfer, for example, and may also be used to refer a patient from one healthcare practitioner to another. Currently, such resources are typically accessed individually and may not be conveniently available to healthcare practitioners.

Currently, sharing of information between colleagues in the field of medicine is difficult and consumes significant time, money, and personnel resources. That is, information is typically transferred physically from one healthcare facility (such as a hospital, clinic, doctor's office, other medical office, or terminal, for example) to another. Additionally, healthcare practitioners currently retrieve individual pieces of information from individual sources. Thus, there is a need for centralized information access to reduce the time, money, and personnel necessary for the sharing of information and resources between healthcare practitioners and/or facilities.

In the field of computers, Application Service Providers (ASPs) have been employed to allow for centralization of data. ASPs operate as hosts for data and applications. Typically, ASPs maintain applications and data in an off-site data center. ASPs have been hired by companies in the field of computers to manage data and computer applications. Companies may access data and applications via an ASP. Typically, in the computer field, companies remotely access data and applications via an ASP central data location.

In the field of computers, ASPs may offer several desirable services, such as secure data storage, data backup, and redundant systems. Because ASPs offer such services, a customer of an ASP may not have to incur additional expenses for its own security, backup, and storage systems. In addition to functioning as a remote database, ASPs may host a number of applications that may be activated or accessed remotely by customers. By concentrating computing power and maintenance at the ASP, the ASP may offer continuous access to and support of the applications and alleviate the need for the customer to purchase and maintain its own expensive computer equipment.

For example, ASPs may provide installation, management, and support of applications and storage of data for many remote clients. Client data may be stored at a remote data center. Data may be retrieved from a remote data center via a communications medium such as the Internet or a private network. Additionally, ASPs may deliver applications such as email systems, resource planning systems, customer relationship management systems, human resource management system, and proprietary applications to remote clients.

A healthcare practitioner's own examination often provides a narrow view of the information needed to provide proper patient care. Further information may assist in the proper care of a patient by providing patient history, medical data, and/or possible treatments, for example. Thus, there is a need for physicians and other healthcare practitioners to access medical content for diagnosis and treatment of patients. There is also a need for communication between doctors and other healthcare professionals for diagnosis and treatment of patients and continued education. There is a further need for access to administrative information and time and patient management tools to improve healthcare facility workflow and healthcare practitioner efficiency.

Centralized access to medical information and resources may improve patient care, education, and knowledge exchange. Centralized information sharing may facilitate collaborative patient care rather than care by an individual healthcare practitioner. A central access point for information and resource access may improve healthcare facility workflow by improving the speed of information transfer, patient diagnosis, and patient treatment.

Additionally, there is a need for improved access to a centralized archive of medical information and resources to improve the exchange of information and the diagnosis and treatment of patients. Improved access to a centralized data archive may improve the speed of information exchange, patient diagnosis, and patient treatment. Improved access may enhance remote retrieval and remote exchange of medical content and medical resources or services. Access to a centralized data archive may increase access to medical content and resources for improved patient care, healthcare practitioner education, and healthcare practitioner communication.

### SUMMARY OF INVENTION

A preferred embodiment of the present invention provides a method and system for integration of a portal into an application service provider data archive and/or web based viewer. In a preferred embodiment, the system includes a data center for storing medical content and/or medical services. The data center is remotely accessible by a portal. The portal allows access to the medical content and/or medical services at the data center. The system also includes a portal/data center connection allowing communication between the portal and the data center. Preferably, the data center is cached and stored at a plurality of locations. Preferably, the data center is an application service provider. Preferably, the data center includes an archive for storing medical content and/or medical services. Preferably, the data center includes a web based viewer for medical content and/or medical services. In a preferred embodiment, the portal is accessible via a web browser. Preferably, the portal is a web site. In a preferred embodiment, the system also includes an external access connection for storing medical content and/or medical services at the data center.

The method includes the steps of accessing a portal and requesting medical content and/or medical services via the portal. The method also includes retrieving the medical content and/or said medical services from a data center and displaying the medical content and/or medical services at the portal. The method also includes accessing the data center via an external access connection and storing medical content and/or medical services at the data center for later retrieval.

### BRIEF DESCRIPTION OF DRAWINGS

FIG. 1 illustrates a medical information system used in accordance with a preferred embodiment of the present invention.

FIG. 2 illustrates a medical information system used in accordance with a preferred embodiment of the present invention.

FIG. 3 illustrates a flowchart for storing and accessing medical content and/or medical services in accordance with a preferred embodiment of the present invention.

### DETAILED DESCRIPTION

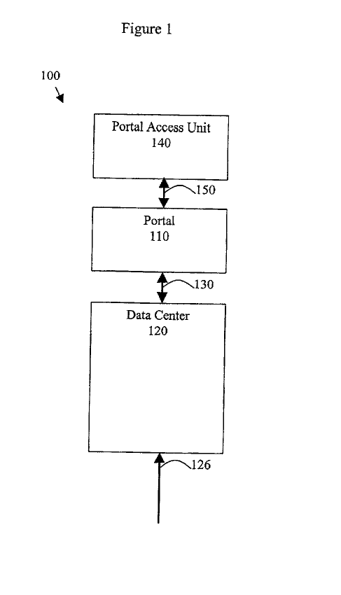

FIG. 1 illustrates a medical information system 100 used in accordance with a preferred embodiment of the present invention. The medical information system 100 includes a plurality of subsystems, such as a portal 110, a data center 120, and a portal/data center connection 130. The data center may also include an external access connection 126. The medical information system 100 may also include a portal access unit 140 and portal access unit/portal connection 150. The portal/data center connection 130 allows the portal 110 to access the data center 120. The portal access unit/portal connection 150 allows the portal access unit 140 to access the portal 110.

In a preferred embodiment, the portal 110 serves as an access point for medical content and/or medical services. Preferably, medical content includes medical image(s) (such as x-ray images, computerized tomography images, ultrasound images, magnetic resonance images, and/or electrocardiograms, for example) and medical information (such as radiology information, patient information, healthcare practitioner information, library information, and/or administrative information, for example), for example. Preferably, medical services include time management tools (such as calendars or planners, for example), educational background services (such as electronic libraries or reference materials, for example), continued education services (such as on-line courses or educational materials, for example), scheduling services (such as operating room schedulers, equipment schedulers, or appointment schedulers, for example), administrative services, healthcare practitioner search services, patient status services, and/or healthcare practitioner communication services (such as “chat” rooms or other electronic conversational media, for example), for example.

In a preferred embodiment, the portal 110 serves as an access point to the data center 120 for retrieval of medical content and/or medical services. Preferably, the portal 110 is a web site which may be accessed remotely by any commercially available web browser, terminal, or other such information access device, for example. In an application service provider (ASP) model, the portal 110, preferably, may be maintained or hosted by a viewer or web server, for example, at the data center 120. The portal 110 may also be maintained or hosted by a viewer or web server, for example, at a healthcare facility (such as a hospital, clinic, doctor's office, or other office, for example). Preferably, the portal 110 serves as a single access point through which healthcare practitioners (such as physicians, technicians, nurses, etc., for example) may access a variety of information (such as medical content and/or medical services, for example) and communicate with other healthcare practitioners. In a preferred embodiment, the portal 110 includes at least one link (or hyperlink) to medical content and/or medical services. That is, the links at the portal 110 provide access to the medical content and/or medical services. A user may select one of the links to retrieve the medical content and/or medical services located at the other end of the link. Preferably, the links direct the user to medical content and/or medical services at the data center 120. That is, a link at the portal 110 provides access to the medical content and/or medical service at the data center 120. Alternatively, the portal 110 may also include additional links to medical content and/or medical services at locations other than the data center 120, such as links to medical libraries and other reference pages, for example. Preferably, links at the portal 110 retrieve medical content from the data center 120 and/or activate medical services at the data center 120.

The portal/data center connection 130 allows the portal 110 to connect to the data center 120. Preferably, links at the portal 110 are connected to the medical content and/or medical services at the data center 120 via the portal/data center connection 130. In a preferred embodiment, the portal/data center connection 130 is a network connection, such as the Internet, ethernet, wireless network, private network, or other such network, for example. The portal/data center connection 130 allows the portal 110 to access and/or activate medical content and/or medical services at the data center 120. Additionally, in an alternative embodiment, the portal/data center connection 130 may allow the portal 110 to store medical content and/or medical services at the data center 120.

In a preferred embodiment, the data center 120 stores and allows access to medical content and/or medical services. Preferably, medical content and/or medical services may be retrieved by the portal 110 via the portal/data center connection 130. In a preferred embodiment, the data center 120 is an application service provider. In an alternative embodiment, the data center 120 may be cached and stored at a plurality of locations. For example, the data center 120 may be distributed over several servers in physically distinct locations. For example, the data center 120 may include multiple computers and databases in different locations that can be centrally accessed. Preferably, the data center 120 includes a processor with sufficient computing power to store medical content and/or activate and/or allow access to medical services. The data center 120 may facilitate the exchange of medical content, medical services, and/or other such information, for example, between healthcare practitioners and/or healthcare facilities, for example.

Additionally, medical content and/or medical services may be stored at the data center 120 via the external access connection 126. Preferably, the external access connection 126 is a network connection, such as the Internet, ethernet, wireless network, private network, or other such network, for example. The external access connection 126 may be used to store medical content and/or medical services from entities such as healthcare facilities, healthcare practitioners, and/or other users, for example, at the data center 120 for retrieval by other entities. For example, an x-ray image may be stored at the data center 120 from a hospital via the external access connection 126. Preferably, when medical content and/or medical services are stored at the data center 120, the portal 110 is updated (for example, links at the portal 110 are updated and/or added). In a preferred embodiment, the portal 110 is automatically updated by the data center 120 when medical content and/or medical services are stored at the data center 120. For example, the medical content and/or medical services are stored at the data center 120 and indexed according to a content identifier, such as a patient's social security number or an application name, for example. The content identifier then becomes a link at the portal 110 and indicates the location of the medical content and/or medical service at the data center 120. In an alternative embodiment, a technician (such as a webmaster or other programmer, for example) updates the portal 110 when medical content and/or medical services are stored at the data center 120. For example, the technician views the directory listing of the medical content and/or medical services stored at the data center 120 and updates the links at the portal 110 (such as by editing the web site html file, for example) with the names of newly stored or updated medical content and/or medical services. Additionally, if medical content or medical services are removed from the data center 120, links may be removed from the portal 110.

In operation, medical content and/or medical services may be retrieved from the data center 120 via the portal/data center connection 130. First, a user may access the portal 110 and request medical content and/or medical services at the portal 110. For example, at the portal 110 the user may select a link to the medical content and/or medical services. Next, the portal 110 accesses the data center 120 via the portal/data center connection 130. Then, the portal 110 retrieves the requested medical content and/or medical services from the data center 120. Finally, the portal 110 displays and/or activates the requested medical content and/or medical services for the user.

In a preferred embodiment, a user may access the portal 110 via the portal access unit 140. Preferably, the portal access unit 140 is a web browser, terminal, or other such information access device, for example. Preferably, the user views the portal 110 via the portal access unit 140 (for example, the user views the web site via the web browser). The portal access unit/portal connection 150 allows the portal access unit 140 to communicate with the portal 110. Preferably, the portal access unit/portal connection 150 is a network connection, such as the Internet, ethernet, wireless network, private network, or other such network, for example. The user may access links to medical content and/or medical services at the portal 110 via the portal access unit 140. The selected medical content and/or medical services are preferably transferred from the data center 120 through the portal/data center connection 130 to the portal 110 and through the portal access unit/portal connection 150 to the portal access unit 140 for use by the user.

As an example of the use of the medical information system 100, consider the following. A physician examines a patient complaining of a headache. Then, the physician refers the patient to a head specialist. Next, the head specialist sends the patient for a computerized tomography (CT) scan of the patient's head. The head specialist may access the application service provider data center 120 to use scheduling services to make an appointment for the patient's CT scan. Then, a CT scan is taken of the patient's head at a mobile imaging unit. The head CT scan is sent to the data center 120. Additionally, a radiologist views the CT scan, evaluates the CT scan, and records a diagnosis of the head CT scan. The report is stored with the head CT scan image at the data center 120. Then, the head specialist may access the portal 110 web site via the portal access unit 140 web browser and access the head CT image and radiologist's report from the data center 120. Additionally, the head specialist may access medical services for additional medical information, such as information on disorders, educational materials, or other medical content, for example, and may communicate with other physicians via the data center 120 communication services and the portal 110. Thus, all healthcare practitioners involved may access the information at the data center 120 via the portal 110.

Additionally, for example, a radiologist or other healthcare practitioner may use the portal 110 and data center 120 to diagnose an image. Using the portal 110, the radiologist may access the data center 120 and view the image that has been stored at the data center 120 by a scanning technician. Then, the radiologist may input a diagnosis into the data center 120. Also, the radiologist may do research using medical services at the data center 120 via the portal 110 on conditions related to the conditions the radiologist sees in the image.

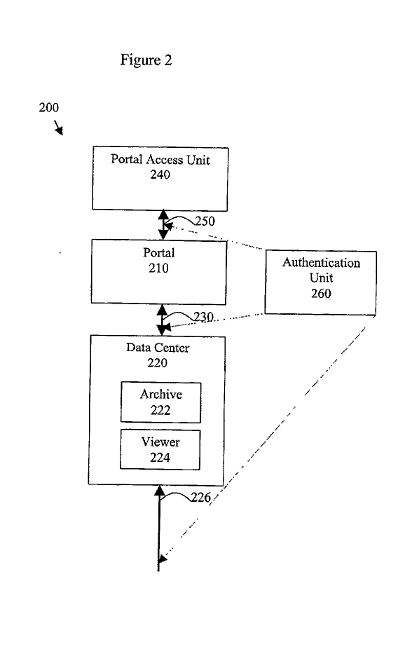

FIG. 2 illustrates an alternative embodiment of a medical information system 200 used in accordance with a preferred embodiment of the present invention. The medical information system 200 is similar to the medical information system 100 described above in reference to FIG. 1 and includes a plurality of subsystems, such as a portal 210, a data center 220, an external access connection 226, a portal/data center connection 230, a portal access unit 240, and a portal access unit/portal connection 250. In addition, the medical information system 200 includes an archive 222, a viewer 224, and an authentication unit 260.

The elements of the medical information system 200 of FIG. 2 connect similarly to the elements of the medical information system 100 of FIG. 1 with the addition of the archive 222 and the viewer 224 as part of the data center 220. Additionally, the authentication unit 260 may be positioned as part of the portal access unit/portal connection 250, the portal/data center connection 230, or both the portal access unit/portal connection 250 and the portal/data center connection 230. The authentication unit may also be positioned as part of the external access connection 226.

The elements of the medical information system 200 of FIG. 2 are similar to the elements of the medical information system 100 of FIG. 1. That is, the portal 210, the data center 220, the external access connection 226, the portal/data center connection 230, the portal access unit 240, and the portal access unit/portal connection 250 of the medical information system 200 are similar in structure and operation to the portal 110, the data center 120, the external access connection 126, the portal/data center connection 130, the portal access unit 140, and the portal access unit/portal connection 150 of the medical information system 100 described above in reference to FIG. 1. In operation, the medical information system 200 of FIG. 2 functions similarly to the medical information system 100 of FIG. 1.

Additionally, the data center 220 may include an archive 222 for storage of medical content and/or medical services. The data center 220 may also include a viewer 224 in which medical content and/or medical services may be stored and/or accessed. Preferably, the medical content and/or medical services are temporarily stored at the viewer 224. Preferably, the viewer 224 is a web server or other such web based viewer, for example. In a preferred embodiment, the portal 210 accesses medical content and/or medical services at the viewer 224 via the portal/data center connection 230. That is, preferably, the portal is a web site that is hosted by the web server embedded in the viewer 224 that allows access to medical content and/or medical services from the archive 222 and/or viewer 224, as further described below. Alternatively, the web site may be hosted at a healthcare facility and may remotely access the web server for access to medical content and/or medical services from the archive 222 and/or viewer 224.

Preferably, the viewer 224 retrieves medical content and/or medical services from the archive 222 and temporarily stores the medical content and/or medical services at the viewer 224 for access by the portal 210. That is, the viewer 224 may temporarily cache the medical content and/or medical services or serve as a conduit between the portal 210 and the archive 222. For example, if the viewer 224 temporarily caches the medical content and/or medical services, the medical content and/or medical services stored most recently at the archive 222 may be stored in the memory cache of the viewer 224 for easy retrieval. Storing medical content and/or medical services in the cache of the viewer 224 may improve the speed of retrieval by the viewer 224 and the portal 210. Alternatively, the viewer 224 may store medical content and/or medical services for access by the portal 210. For example, the viewer 224 is a web server and may also include disk memory to store the medical content and/or medical services. The external access connection 226 may be used to store medical content and/or medical services at the viewer 224. The external access connection 226 may also be used to store medical content and/or medical services at the archive 222.

For example, a patient is examined by a family doctor at the doctor's office. The doctor compiles a report from the examination of the patient. The doctor accesses the data center 220 via the external access connection 226 (such as by using the Internet to connect to the data center 220 from a personal computer in the doctor's office). Then, the doctor stores the patient's examination report at the archive 222. Additionally, the patient's examination report may be stored in the cache of the viewer 224 as the most recently stored medical content. Also, the data center 220 adds a link to the patient's examination report at the portal 210. Next, the doctor accesses the portal 210 via the portal access unit 240 (such as a web browser on a personal computer in the doctor's office, for example). Then, the doctor selects a link for scheduling services (such as an appointment scheduling service) at the portal 210. The portal 210 accesses the data center 220 and requests scheduling services. The viewer 224 allows the portal 210 to access scheduling services at the archive 222.

Next, for example, the doctor schedules an x-ray for the patient at a hospital using the scheduling services. Then, the patient is x-rayed at the hospital. An x-ray technician accesses the data center 220 via the external access connection 226 and stores the x-ray image at the archive 222. The portal 210 is updated with a link to the x-ray image. Additionally, the x-ray image may be stored in the cache of the viewer 224 as the most recently stored medical content. A radiologist may then access the portal 210. The radiologist may then select the patient's x-ray image and patient's examination report at the portal 210 and retrieve them from the data center 220. If the x-ray image and examination report both reside in the cache of the viewer 224, the speed of access from the data center 220 may be increased. If the x-ray image and examination report have been replaced in the cache of the viewer 224, the x-ray image and examination report may be retrieved from the archive 222 by the viewer 224 and displayed at the portal 210. Then, the radiologist views the patient's x-ray image and examination report at the portal 210. Next, the radiologist may diagnose the patient based on the x-ray image and examination report. Then, the radiologist may record the diagnosis and store the diagnosis at the archive 222 via the portal 210. Later, the doctor may again access the portal 210 via the portal access unit 240 and retrieve the radiologist's recorded diagnosis from the data center 220. The doctor may then communicate with the patient and explain the radiologist's diagnosis to the patient.

Additionally, the medical information system 200 provides medical services, such as communication services between healthcare practitioners, along with medical content. For example, if a first healthcare practitioner wants to discuss a problem with a second healthcare practitioner, the first healthcare practitioner may contact the second healthcare practitioner by accessing the portal 210 (a web site) with the portal access unit 140 (a web browser). At the portal 210, the first healthcare practitioner may access the medical services (such as communication services, for example) at the data center 220. That is, the first healthcare practitioner may select a link for communication services at the web site and thereby activate a communication session (a “chat” session) via the viewer 224 (a web server). The first healthcare practitioner may communicate with the second healthcare practitioner via the web server chat session at the web site. Additionally, while conversing on-line with the second healthcare practitioner, the first healthcare practitioner may select links for medical content (such as a medical image or report). The web server then retrieves the selected content from the archive 224 and temporarily stores the medical content for access by the first healthcare practitioner at the web site.

In an alternative embodiment, which may be applied to any of the embodiments disclosed herein, the authentication unit 260 is used to protect the contents of the data center 220 and/or portal 210. That is, the portal 210 may transmit an authentication code to the authentication unit 260 in order gain access to the data center 220 via the portal/data center connection 230 to transmit or receive medical content and/or access medical services. Additionally, an authentication code may be transmitted to the authentication unit 260 in order to gain access to the data center 220 via the external access connection 226. Also, in an alternative embodiment, the portal access unit 140 may transmit an authentication code to the authentication unit 260 in order to gain access to the portal 210 via the portal access unit/portal connection 250.

In operation, in any of the above embodiments, the authentication unit 260 receives an authentication code. Then, the authentication unit 260 compares the received authentication code with a predetermined authentication code. If the authentication code matches the predetermined authentication code, then the authentication code has been verified by the data center 220 and/or portal 210 and access to the data center 220 and/or portal 210 is granted. That is, if the authentication code is verified, the authentication unit 260 allows access to the data center 220 and/or portal 210. In one embodiment, the authentication code includes a secure identification key. Preferably, the secure identification key is a periodically changing number. The secure identification key may be embodied in a device that generates a periodically changing number. Additionally, the authentication code may include an identification number (preferably a personal identification number) along with the secure identification key. Alternatively, the authentication code may be a password. The authentication code may be assigned according to an individual user, a group of users, a location, and/or a function, for example.

For example, a physician wishes to access the portal 210 via a web browser. First, the physician directs the web browser to the URL (uniform resource locator) address of the portal 210. Then, before the portal 210 web page loads, the authentication unit 260 requests an authentication code (such as by popping up a window with a password field, for example). The physician enters an authentication code (such as a password, for example) to access the portal 210. The authentication unit 260 then attempts to verify the authentication code. If the authentication unit 260 does not verify the authentication code, then the physician may not access the portal 210, although the authentication unit 260 may allow the physician to attempt to re-enter the authentication code. If the authentication unit 260 verifies the authentication code, the physician may access the portal 210. That is, the web page loads via the physician's web browser.

The portal 210 web page may contain links to medical content and/or medical services. The physician may scan the links to find the desired medical content (such as a medical diagnostic image or report, for example). Then, the physician may select a link to medical content (such as by clicking on the link with a computer mouse, for example) at the portal 210. Before retrieval of the medical content may proceed, the authentication unit 260 requests an authentication code. The authentication code (such as a secure identification key, for example) may be sent by the portal 210 or entered by the physician and sent by the portal 210 to the authentication unit 260. The authentication unit 260 then attempts to verify the authentication code. If the authentication unit 260 does not verify the authentication code, then the physician may not retrieve the requested medical content. If the authentication unit 260 verifies the authentication code, the medical content is retrieved from the data center 220 and is accessible at the portal 210.

Additionally, for example, the physician may store medical content (such as a medical image or report, for example) at the data center 220. The physician may access the external access connection 226 such as by using a web browser on a personal browser. Before the physician may access the data center 220 via the external access connection 226, the authentication unit 260 requests an authentication code. The physician enters an authentication code (such as a personal identification number, for example) to access the data center 220. The authentication unit 260 then attempts to verify the authentication code. If the authentication unit 260 does not verify the authentication code, then the physician may not access the data center 220 via the external access connection 226. If the authentication unit 260 verifies the authentication code, the physician may access the data center 220 via the external access connection 226. Then, the physician may store the medical content at the data center 220 (such as at the archive 222, for example).

Preferably, medical content is protected by the authentication unit 260. Medical services may also be protected by the authentication unit 260. In an alternative embodiment, communication services are not protected by the authentication unit 260. That is, users may communicate with other users without an authentication code, but an authentication code is used to access other medical content and medical services.

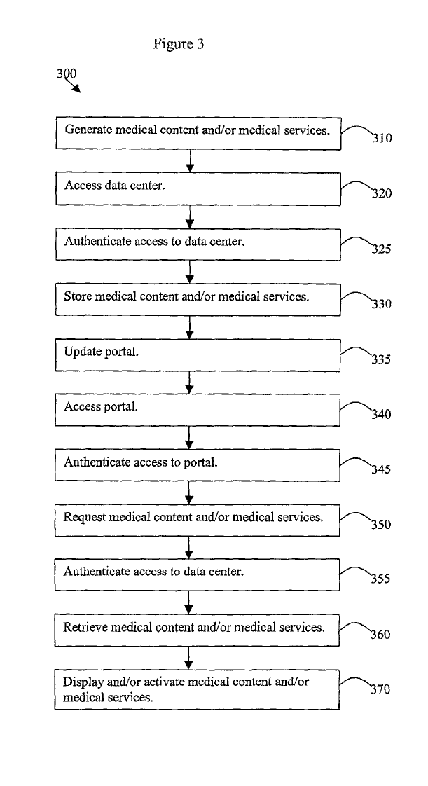

FIG. 3 illustrates a flowchart 300 for storing and accessing medical content and/or medical services in accordance a preferred embodiment of the present invention. Storage of medical content and/or medical services at a data center may proceed as follows. First, at step 310, medical content and/or medical services may be generated by a healthcare facility, healthcare practitioner, or other entity, for example. For example, an x-ray technician obtains an x-ray image of a patient using an x-ray imaging system at a hospital.

Next, at step 320, the data center may be accessed by a medical content provider via an external access connection. The medical content provider may include a computer system, a medical diagnostic system, a terminal, or other such system, for example. A computer system may include a picture archiving and communications system or a local database system, for example. A medical diagnostic system may include an x-ray imaging system, an ultrasound imaging system, a computerized tomography system, an electrocardiogram system, and/or a magnetic resonance imaging system, for example. For example, the x-ray imaging system may access the data center via an ethernet connection.

Then, at step 325, access to the data center is authenticated using an authentication code, such as an authorization code, an identification code, or a password, for example. If the authentication code matches a predetermined authentication code, the authentication code is verified, and access to the data center is authorized. For example, the x-ray imaging system transmits an identification code to gain access to the data center.

Then, at step 330, the medical content and/or medical services may be stored at the data center by the medical content provider. That is, the medical content and/or medical services may be transferred from the medical content provider to the data center via the external access connection. Additionally, the medical content and/or medical services may be encrypted or otherwise protected during transfer to the data center and unencrypted at the data center. At the data center, the medical content and/or medical services may be stored at an archive and/or at a viewer. For example, once an ethernet connection is established between the x-ray imaging system and the data center, the x-ray image is stored at the archive of the data center.

At step 335, the portal (such as a web site or web page, for example) that serves as an access point to the data center for medical content and/or medical services may be modified or updated to reflect changes at the data center. That is, new link(s) may be added at the portal to represent the medical content and/or medical services stored at the data center. The link(s) may be added at the portal automatically by the data center or manually by a technician, for example, as further described above. For example, after the x-ray image is stored at the archive, the data center adds a link to the x-ray image at the portal web site maintained at the data center's web server or viewer.

Retrieval of medical content and/or medical services may proceed as follows. First, at step 340, a user may access the portal. Preferably, the user accesses the portal using a portal access unit, such as a web browser, a terminal, or other such information access device, for example. For example, a radiologist wants to view the x-ray image to diagnose the patient. Thus, the radiologist uses a web browser at a personal computer to access the web site hosted by the web server at the data center. Next, at step 345, the access of the portal is authenticated using an authentication code (such as an authorization code, an identification code, and/or a password, for example) to verify that the access of the portal is authorized. For example, the radiologist enters a password to access the content of the web site.

Next, at step 350, medical content and/or medical services may be requested at the portal. Preferably, medical content and/or medical services may be requested by selecting a link at the portal. For example, the radiologist selects the link at the web site to the patient's x-ray image. Then, at step 355, access to the data center for retrieval of the selected medical content and/or medical services is authenticated using an authentication code (such as an authorization code, an identification code, and/or a password, for example) to verify that access to the data center is authorized. For example, the web browser transmits an authorization code to the data center for access to the content at the data center.

Then, at step 360, the medical content and/or medical services are retrieved from the data center. Preferably, the medical content and/or medical services are transferred from the archive to the viewer (for example, temporarily stored in the cache of the web server) for access at the portal. Alternatively, the medical content and/or medical services may be retrieved directly from the viewer for access at the portal. For example, after the link to the x-ray image is selected, the web server retrieves the x-ray image from the archive and temporarily stores the x-ray image in the cache of the web server. Finally, at step 370, the medical content and/or medical services may be displayed and/or activated at the portal. For example, the x-ray image is displayed at the web site, and the radiologist may view the x-ray image and diagnose the x-ray image.

Thus, the preferred embodiments of the present invention allow centralized access to a variety of medical content and medical services. The preferred embodiments enhance the information available to healthcare practitioners in diagnosing and treating patients and in increasing their own knowledge. Additionally, the preferred embodiments allow collaboration between healthcare practitioners as well as encouraging communication between healthcare practitioners. That is, general practitioners may communicate and exchange ideas with specialists, and specialists may communicate with other specialists, for example. The preferred embodiments of the present invention provide a centralized method for the storage, retrieval, and exchange of medical content and medical services. Preferably, retrieval, exchange, and/or storage of medical content and/or medical services may be accomplished using a portal access unit, such as a healthcare practitioner's web browser, for example, to access the portal web site and retrieve medical content and/or medical services from the data center web server.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments failing within the scope of the appended claims.

1. A centralized medical information system, said system comprising:
a remote data center for storing medical content, said remote data center remotely accessible by a portal;
a portal capable of accessing said remote data center to retrieve said medical content; and
a portal/data center connection allowing communication between said portal and said remote data center.

2. The system of claim 1, wherein said portal is accessible via a web browser.

3. The system of claim 1, wherein said portal comprises a web site.

4. The system of claim 1, wherein said remote data center comprises a web server.

5. The system of claim 1, wherein said remote data center is cached and stored at a plurality of locations.

6. The system of claim 1, wherein said remote data center comprises an application service provider.

7. The system of claim 1, wherein said portal allows said medical content to be stored at said remote data center.

8. The system of claim 1, further comprising a web browser capable of accessing said portal.

9. The system of claim 1, further comprising an external access connection for storing said medical content at said remote data center.

10. The system of claim 1, further comprising an authentication unit for authorizing access to said remote data center.

11. The system of claim 1, further comprising an authentication unit for authorizing access to said portal.

12. The system of claim 1, wherein said remote data center further stores medical services.

13. The system of claim 1, wherein said portal further allows access to medical services.

14. A method for accessing medical content, said method comprising:
accessing a portal;
requesting said medical content via said portal; and
retrieving said medical content from a remote data center.

15. The method of claim 14, further comprising the step of displaying said medical content via said portal.

16. The method of claim 14, wherein said data center comprises an application service provider.

17. The method of claim 14, wherein said portal comprises a web site.

18. The method of claim 14, wherein said portal comprises at least one link to said medical content.

19. The method of claim 18, wherein said step of requesting comprises selecting one of said at least one link at said portal.

20. The method of claim 14, wherein said remote data center is cached and stored at a plurality of locations.

21. The method of claim 14, wherein said step of accessing a portal further comprises accessing a portal via a web browser.

22. The method of claim 14, wherein said accessing step further comprises authenticating said access to said portal.

23. The method of claim 14, wherein said retrieving step further comprises authenticating said retrieval of said medical content from said remote data center.

24. The method of claim 14, further comprising:
requesting medical services via said portal;
accessing said medical services via said remote data center; and
activating said medical services via said portal.

25. An information portal, said portal comprising:
a web site for accessing medical content, said web site providing access to a remote data center storing said medical content.

26. The portal of claim 25, further comprising a web browser for viewing said web site.

27. The portal of claim 25, further comprising a portal/data center connection allowing communication between said web site and said remote data center.

28. The portal of claim 25, wherein said remote data center comprises a web server.

29. The portal of claim 25, wherein said remote data center is cached and stored at a plurality of locations.

30. The portal of claim 25, wherein said remote data center comprises an application service provider.

31. The portal of claim 25, further comprising an authentication unit for authorizing access to said web site.

32. The portal of claim 25, further comprising an authentication unit for authorizing access to said remote data center.

33. The portal of claim 25, wherein said web site further provides access to medical services at said remote data center.

34. A method for storing medical content at a remote data center, said method comprising:
accessing said remote data center via an external access connection; and
storing said medical content at said remote data center.

35. The method of claim 34, wherein said storing step further comprises authenticating said storing of said medical content at said remote data center.

36. The method of claim 34, wherein said remote data center comprises an application service provider.

37. The method of claim 34, wherein said remote data center is cached and stored at a plurality of locations.

38. The method of claim 34, further comprising:
accessing a portal to request said medical content from said remote data center; and
retrieving said medical content from said remote data center.

39. The method of claim 38, further comprising the step of displaying said medical content via said portal.

40. The method of claim 38, wherein said portal comprises a web site.

41. The method of claim 38, wherein said portal comprises at least one link to said medical content.

42. The method of claim 38, wherein said step of accessing said portal comprises selecting one of said at least one link at said portal.

43. The method of claim 38, wherein said step of accessing a portal further comprises accessing a portal via a web browser.

44. The method of claim 38, wherein said accessing step further comprises authenticating said access to said portal.

45. The method of claim 38, wherein said retrieving step further comprises authenticating said retrieving said medical content from said remote data center.

46. The method of claim 34, further comprising the step of updating a portal capable of accessing said medical content at said data center to reflect said storing of said medical content at said data center.

47. The method of claim 34, further comprising the step of storing medical services at said remote data center.

48. A centralized medical information system, said system comprising:
a remote data center for storing medical content and medical services, said remote data center remotely accessible by a portal;
a portal capable of accessing said remote data center to retrieve said medical content and medical services; and
a portal/data center connection allowing communication between said portal and said remote data center.

49. A web based centralized medical information system, said system comprising:
a remote data center for storing medical content, said remote data center having a web server, said web server remotely accessible by a web site; and
a web site capable of accessing said web server to retrieve said medical content.

50. The system of claim 49, wherein said remote data center stores medical services.

51. The system of claim 49, wherein said web site is capable of accessing said web server to retrieve medical services.
